(19) United States
(12) Patent Application Publication
(10) Pub. No.: US 2008/0309973 A1
(43) Pub. Date: Dec. 18, 2008

(54) IMAGE OUTPUT SYSTEM

(76) Inventor: Kazuhiro OKAMOTO, Sakurai-shi (JP)

Correspondence Address: BIRCH STEWART KOLASCH & BIRCH, PO BOX 747, FALLS CHURCH, VA, 22040-0747, US

(21) Appl. No.: 12/137,917

(22) Filed: Jun. 12, 2008

(30) Foreign Application Priority Data
Jun. 15, 2007 (JP) 2007-158168

(51) Int. Cl. G06F 3/12; G06K 15/00

(52) U.S. Cl. 358/1.15

(57) ABSTRACT

An output management apparatus which distributes a job composed of a plurality of pages to respective printers and a plurality of image processing apparatuses which print images for each page according to instructions from the output management apparatus are connected via a network. The output management apparatus creates an output map used by the user to collect printed matter from each printer. The output map includes page information on the page outputted to each printer for each printer. The page information is arranged in the output map in output order or printers are arranged in order of collection. Therefore, after a job is distributed and outputted to a plurality of printers in page units, the user can efficiently collect printed matter.

### BACKGROUND OF THE INVENTION

1. Field of the Invention

The present invention relates to an image output system which performs distribution processing on a job using a plurality of image processing apparatuses

2. Description of the Related Art

Image processing apparatuses process a job composed of a plurality of pages and print images of the pages. There are a variety of job contents, and color pages, monochrome pages or pages in different sizes such as A3/B3 may be mixed in one job. When processing such a job, an image processing apparatus having processing power appropriate for each page should be used to realize faster processing of higher quality and at lower cost.

Therefore, an output management apparatus which performs distribution processing on a job is connected to a plurality of image processing apparatuses via a network as an image output system for performing distribution processing on the job. The output management apparatus distributes the job to a plurality of image processing apparatuses and each image processing apparatus prints an image of each page.

To manage this distribution processing, Japanese Patent Laid-Open No. 10-198533 describes that an image processing apparatus which has done a job and pages of the job outputted by this image processing apparatus are associated with each other and stored as a job summary.

A job composed of a plurality of pages is distributively outputted to the respective image processing apparatuses. In the respective image processing apparatus, printed matter such as a recording sheet on which a page image is printed is collected. The user goes to each image processing apparatus and collects the printed matter. However, the user does not know which image processing apparatus printed which page. Therefore, the user needs to patrol all the image processing apparatuses and collect the printed matter, which is inefficient. According to the job summary described in the Japanese Patent Laid-Open No. 10-198533, it is possible to know the image processing apparatus to which each page is outputted. However, since the job summary is not created For use by the user, the user cannot use the job summary.

Furthermore, when pages of one job are outputted in a distributed manner, the user must collect the printed matter and then rearrange the printed matter in page order and such rearrangement takes time Even when the output has been done efficiently through distribution processing, if the work after the output takes time, the merit of the distribution processing is canceled out. Moreover, if printed matter of other jobs is mixed, the printed matter may be rearranged wrongly or mistaken, producing paging disorder or missing of pages.

In view of the above described problems, it is an object of the present invention to provide an image output system designed to be able to output pages distributed to a plurality of image processing apparatuses and then allow the user to efficiently perform operations such as collection and rearrangement of printed matter.

### SUMMARY OF THE INVENTION

The present invention provides an image output system comprising a plurality of image processing apparatuses and an output management apparatus connected together via a network, the output management apparatus distributing a job composed of a plurality of pages to respective image processing apparatuses and the image processing apparatuses printing images for each page according to instructions from the output management apparatus, wherein the output management apparatus creates an output map for use by a user to collect printed matter from the respective image processing apparatuses, showing page information on a page outputted to each image processing apparatus for each image processing apparatus.

The output management apparatus distributively outputs the respective pages of the job to different image processing apparatuses. In this case, an output map is created which shows to which image processing apparatus each page has been outputted. By viewing the output map, the user can know which image processing apparatus has printed each page of the job. Therefore, the user can easily collect printed matter from the image processing apparatuses according to the output map. The user can then rearrange the printed matter for each job in page order without errors.

The output management apparatus creates the output map based on a printing load for each page when printing images of the pages. In this way, the output map includes page information arranged in order of output at the respective image processing apparatuses.

The output management apparatus outputs each page based on the printing load of the page by taking processing power of each image processing apparatus into consideration For this reason, the respective pages of the job are distributed. In such a case, using the output map makes it possible to recognize the image processing apparatus from which the page is outputted and easily collect the printed matter.

The output management apparatus creates an output map based on an optimum patrol path between the respective image processing apparatuses. In this way, the output map includes information on the image processing apparatuses arranged in order of collection.

The output management apparatus outputs each page by placing prime importance on the collection efficiency of the printed matter. That is, pages whose printing takes time are outputted to image processing apparatuses in low order of collection. If the user collects printed matter while patrolling the respective image processing apparatuses according to the output map, the user can collect the printed matter without waiting time.

The output map includes page information arranged in page order for each job. The output map further includes index information indicating features of an image of each page. Referring to the index information allows immediate recognition of the image of the page and thereby lessens errors during collection and rearrangement.

According to the present invention, the user can efficiently collect printed matter of each page outputted in a distributed manner using the output map. Moreover, when arranging the printed matter for each job or rearranging the printed matter in page order, using the output map also allows the user to perform operation after output without errors.

### BRIEF DESCRIPTION OF THE DRAWINGS

FIG. 1 shows a schematic configuration of an image output system of the present invention;

FIG. 2 is a flowchart for creating an output map during distribution processing;

FIG. 3 shows a page mapping table;

FIG. 4 shows an output map;

FIG. 5 is a flowchart for creating an output map during distribution processing according to another embodiment;

FIG. 6 shows the output map according to the other embodiment;

FIG. 7 is a flowchart for creating the output map during distribution processing according to the other embodiment;

FIG. 8 shows moving cost between printers; and

FIG. 9 shows an output map according to the other embodiment.

### DETAILED DESCRIPTION OF THE PREFERRED EMBODIMENTS

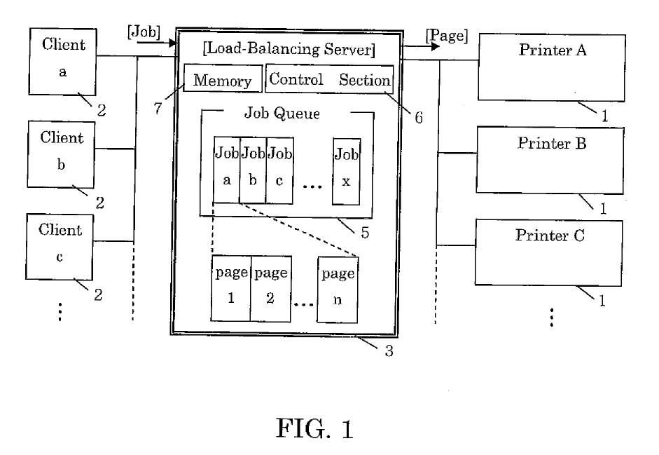

FIG. 1 shows an image output system of this embodiment. The image output system is comprised of printers 1 which are image processing apparatuses, client apparatuses 2 and a load balancing server 3 which is an output management apparatus, connected together in a communicable manner via a network such as a LAN. A plurality of printers 1 and a plurality of client apparatuses 2 are connected to the network.

The client apparatus 2 is a general computer having a communication function. The client apparatus 2 has an application such as word processing software and creates data such as a document using this application. The client apparatus 2 then converts data to an image using a printer driver mounted therein and generates a job composed of a plurality of pages. The client apparatus 2 sends the job to the server 3.

The printer 1 processes the image of the page and prints the image on a recording sheet. This causes the printer 1 to form printed matter made up of the recording sheet on which the image is printed. The printer 1 may be an MFP which executes various processings such as copy, printing, scanning, facsimile communication or document filing. Furthermore, the client apparatus 2 may be an image processing apparatus.

The load balancing server 3 is a general computer having a communication function. The server 3 has a job queue 5 which saves inputted jobs. A newly inputted job is added to a queue formed of previously inputted jobs. A control section 6 carries out distribution processing on a job and divides respective pages among different printers 1. That is, the control section 6 analyzes the job in page units, determines an appropriate printer 1 to which the page is outputted and outputs an image of the page to the printer 1. When dividing the pages, the control section 6 selects an optimum printer 1 as the output destination according to a specified algorithm.

The control section 6 then creates an output map which shows page information on the outputted page for each printer 1. The page information includes the output destination printer 1, job name, page number and number of copies. The output map shows information on the output destination of each page of the divided job. Therefore, the user can efficiently collect printed matter using the output map when collecting printed matter from each printer 1.

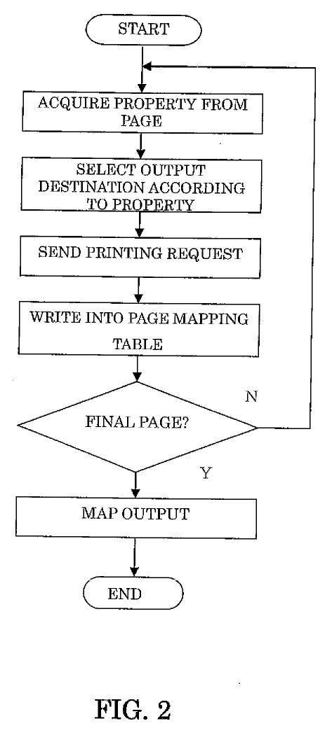

Next, the procedure for distribution processing in this image output system will be explained according to FIG. 2. The control section 6 of the server 3 acquires and checks properties of pages sequentially starting from the start page for each job saved in the job queue 5. The page property is a color/monochrome, sheet size or the like and becomes criteria when determining the output destination printer 1.

The control section 6 selects an optimum printer 1 based on a specified algorithm according to the property of the page. The control section 6 sends a request for printing the corresponding page together with the image of page to the selected printer 1.

Here, each page is distributed by placing special emphasis on a group of jobs and giving priority to the page order. That is, the control section 6 distributes pages based on such an algorithm that pages are distributed consecutively and in page order for one job for each printer 1. When the output destination is selected, a plurality of appropriate printers 1 may be selected depending on the page. In this case, the same printer 1 is selected with priority given to the page order so that pages are continuous.

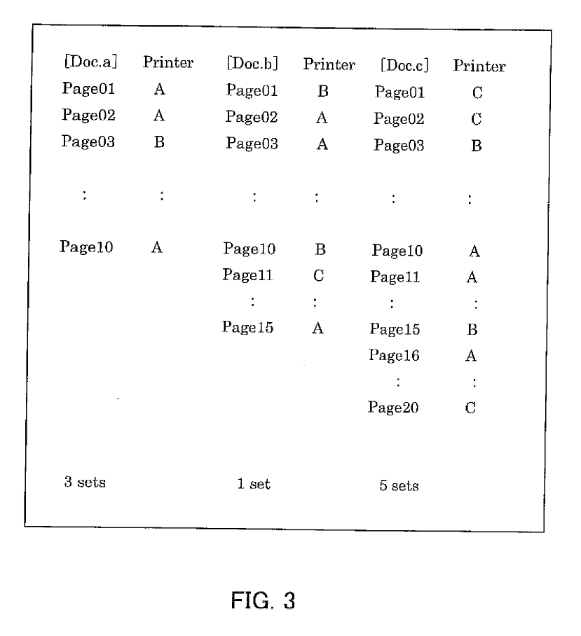

The control section 6 creates a page mapping table as shown in FIG. 3. The page mapping table includes page information on all pages subject to distribution processing. Index information indicating features of images of the pages is added as required. The index information includes thumbnail images of pages and text digests. That is, the page mapping table shows the correspondence between each page and output destination printer 1 for each job. The control section 6 saves the page mapping table created in a memory 7 such as a non-volatile memory or hard disk. The page mapping table may also be created for each job. In this case, the job name is not necessary.

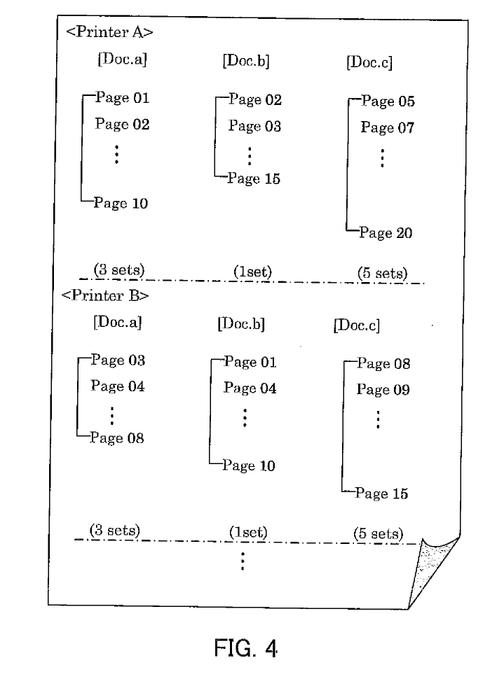

The control section 6 writes page information of each page into the page mapping table. When writing of the final page is completed, the control section 6 creates an output map based on the page mapping table as shown in FIG. 4. The output map is saved in a memory 7.

The control section 6 arranges the respective pieces of page information in page order for each job. The display order on the output map follows the priority order such as job order and page order. The display order of printers 1 is optional.

Upon receiving a printing request, the printer 1 processes the image of the page, prints the image on a recording sheet and forms printed matter.

The control section 6 of the server 3 outputs the created output map so as to be available when the user collects the printed matter. As an output mode, the output map is sent to the printer 1 and the output map is printed or the output map is displayed on a display device of the server 3. That is, the output map is outputted in a mode visible to the user.

The output map may be created and outputted for each printer 1 instead of being created for all the printers 1. The user can know each page of the job outputted at the corresponding printer 1. Alternatively, the output map may also be created and outputted for each job. In one job, the user can know pages outputted for each printer 1.

The user collects printed matter of each page in job units from each printer 1 according to the output map. Since the printed matter collected from each printer 1 is arranged in page order, the user can easily rearrange the printed matter without errors with reference to the output map. Therefore, the work efficiency after the output is improved and an image output system with high processing efficiency can be thereby constructed.

In the above described distribution processing, distribution of pages is completed in job units. Moreover, since the output order also matches the page order, the processing is sequential and the load on the output scheduling processing itself is small. Since the output order of the printed matter also matches the page order, there is a merit that subsequent rearrangement is also relatively simple. Therefore, this distribution processing is suited to such a simple request that pages should be merely outputted in color or monochrome or by being divided by sheet size rather than a request for improving a total printing speed.

As another mode of distribution processing, a top priority is given to the printing speed and respective pages are distributed to the printers 1. The server 3 distributes each page taking the processing power of the printers 1 into consideration based on the printing load of each page. The printing load is assumed to he a time required for printing. When, for example, the amount of data of an image is large, the printing load is large. When the processing on an image to be printed is complicated, the printing load is large. The server 3 distributes each page so that the printing time of the page becomes shortest.

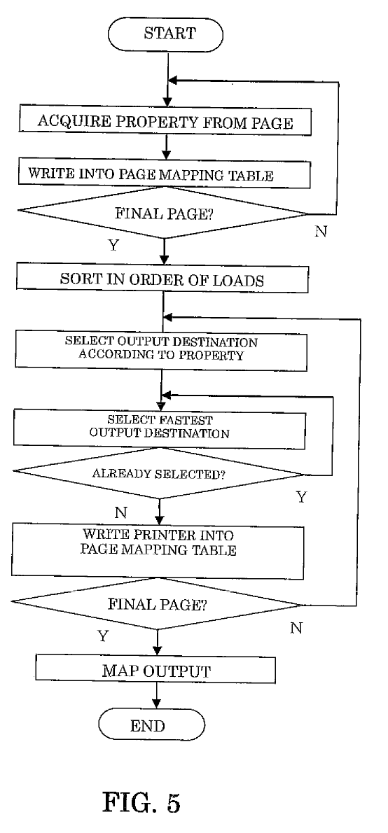

As shown in FIG. 5, the control section 6 of the server 3 acquires a page property. The page property includes color/monochrome, sheet size, printing load or the like. When there is no information corresponding to the printing load, the load on each page is relatively determined based on a data format or data size and this relative value is a printing load.

The control section 6 writes page information on each page into the page mapping table. The page information includes the job name, page number, number of copies, property of the page, and pointer for page data. Furthermore, index information may also be included.

When page information on all pages in the job queue 5 is written, the control section 6 sorts the pages in descending order of printing load based on the printing load. Printer candidates available for output are selected according to the property of each page sorted in load order. Hereafter, a printer 1 having the highest processing power is selected from among the candidates based on a specified algorithm. When this optimum printer 1 is not any already selected printer 1, the control section sends the request for printing the corresponding page together with the image of the page to the selected printer 1. Data related to the page to be sent can be easily referenced using a pointer included in the page information. When the candidates printers 1 available for output are selected, the printer 1 selected as the optimum printer 1 will be excluded from the selectable candidates thereafter. The excluded printers 1 will be restored as selectable candidates after one cycle of distribution of pages to other printers 1 is completed.

When selecting the printer 1, processing power information of each printer 1 is required separately. The server 3 can automatically acquire the processing power information according to query information of each printer 1 or the like. However, since reading query information every time distribution processing is carried out is wasteful, it is desirable that a database be established in advance and the server 3 store the database.

As for an optimization algorithm of load balancing, various mathematic methods are proposed and therefore one best suited to the scale of the system may be selected. Here, an algorithm is used whereby pages are simply distributed starting from the one having a largest printing load to the printers 1 in descending order of processing power.

The control section 6 writes the printer 1 selected for each page into the page mapping table. In this case, the determined output order is also written into the page mapping table. The control section manages transmissions of output requests based on this output order.

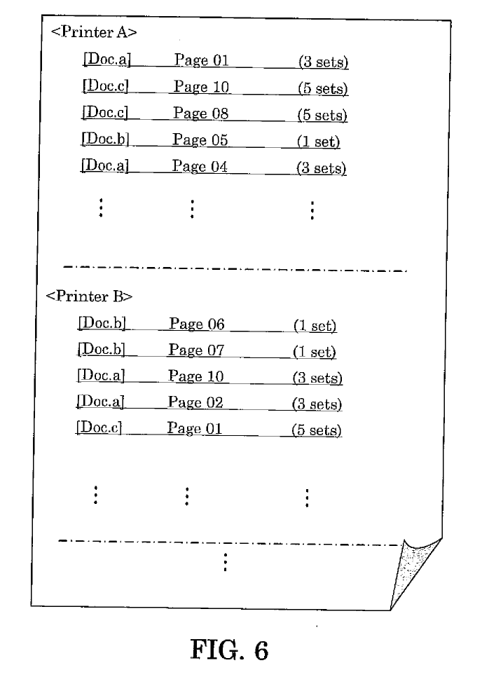

When writing of all pages is completed, the control section 6 creates an output map based on the page mapping table as shown in FIG. 6. The output map is stored in the memory 7.

The control section 6 arranges page information on pages outputted at each printer 1 in output order. The output order of pages is determined with a top priority given to the printing speed, and therefore this output map is written in page units and the arrangement thereof appears to be utterly irregular when seen in job units or in page number units. The notation order of the printers 1 is optional.

Upon receiving a printing request, the printer 1 processes the image of the page, prints the image on a recording sheet and forms printed matter.

The control section 6 of the server 3 outputs the output map created as described above so as to be available when the user collects the printed matter. The user collects the printed matter of each page from each printer 1 according to the output map.

By the way, the printed matter of each printer 1 is arranged independently of jobs in no particular order. However, the use of the output map allows the user to pick up printed matter of a page necessary for each job and arrange printed matter of each page in job units without errors.

This embodiment preferably includes index information in the output map. The index information allows recognition of contents of a page at a glance and can eliminate errors in picking up printed matter. The above described distribution processing performs output scheduling processing for the pursuit of printing speed, and is therefore suitable for such a request as to confirm output contents as soon as possible.

Another mode of distribution processing is to distribute respective pages to the corresponding printers 1 with a top priority given to the efficiency during collection of printed matter. The server 3 distributes respective pages based on an optimum patrol path between the printers 1. In order to eliminate the necessity for shuttling between the printers 1 many times, pages distributed to each printer 1 are put together into one group and pages with a heavier printing load are assigned to printers 1 to be collected later. Adjusting such an output schedule allows the printing time to be concealed in the moving time between the printers 1 and shortens the apparent waiting time.

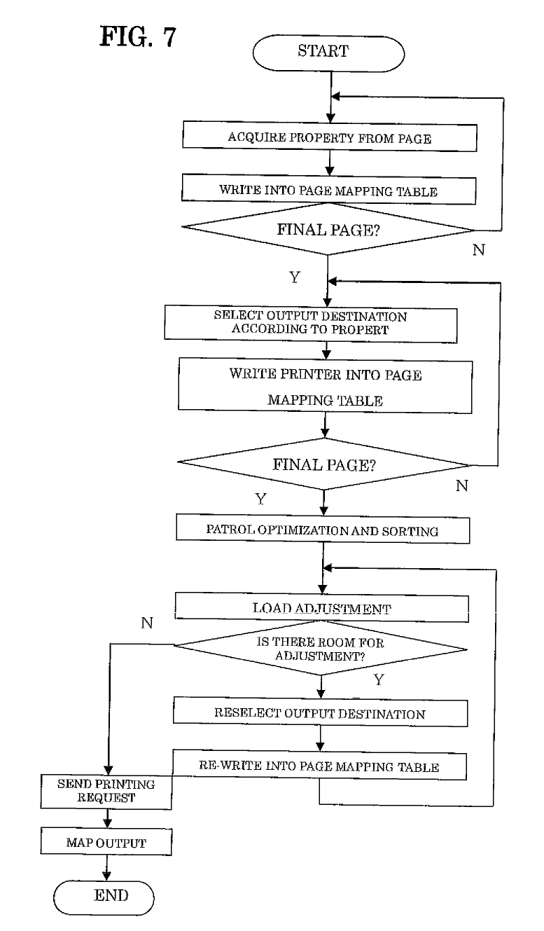

As shown in FIG. 7, the control section 6 of the server 3 acquires a property of the page. The property of the page includes color/monochrome, sheet size, printing load or the like.

The control section 6 writes page information on each page into the page mapping table. The page information includes a job name, page number, number of copies, property of the page and pointer to page data. The page information can also include index information.

After completely writing page information on all pages into the job queue 5, the control section 6 selects output destination printers 1 suitable for the respective pages based on a specified algorithm according to the property of the pages. The algorithm here finds condition matching starting from smaller moving cost of the printers 1. The “moving cost” means a time for a person to move to collect the printed matter. In this case, unless a remote printer 1 cannot help but be used due to the function of the printer 1, selections of printers 1 far from the client apparatus 2 should be avoided.

The control section 6 writes the selected printers 1 into the page mapping table. When writing of the final page is completed, the control section 6 determines the order of printers 1 using a patrol optimization algorithm. Sorting on the page matching table is performed in order of printers based on this determination.

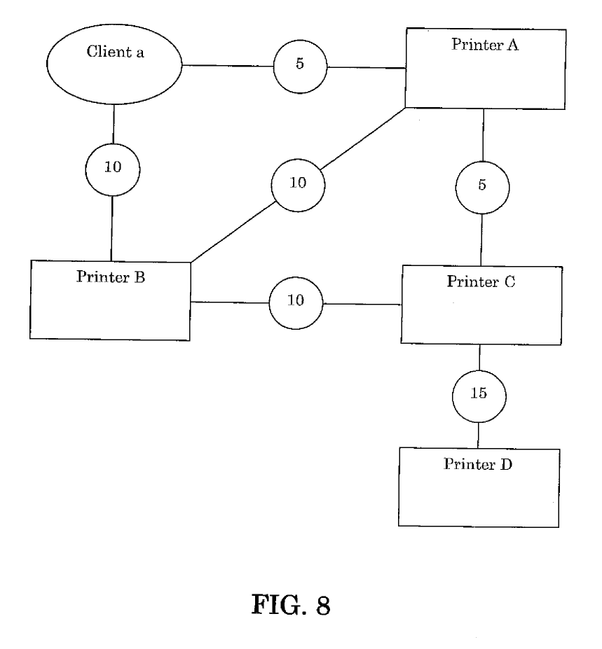

Determining an optimum patrol path requires a moving path and moving cost between the printers 1; or moving time information here. As shown in FIG. 8, the moving path and moving cost are set beforehand. Numbers shown in the figure denote moving cost values (moving time, e.g., 10 minutes). The moving information set in this way is determined when the printer 1 is set. The server 3 inputs this moving information beforehand. The moving information is updated every time the setting location of the printer 1 or client apparatus 2 is changed or newly set.

Furthermore, when a plurality of locations are patrolled, the method of calculating a path with minimum moving cost is known as a mathematical problem commonly called a “traveling salesman problem” and there are several efficient approximation solutions such as “branch and bound method” and “plane cutting method.” The control section 6 guides an optimum patrol path between the printers 1 using such solutions.

The control section 6 then calculates a printing load for each printer 1 for load adjustment. The printing load of each printer 1 is obtained from the sum total of printing loads of the respective pages associated with the respective printers 1. That is:

“Printing load of certain printer”=Σ (“page load related to the printer”)

When this value is smaller than the sum total of moving cost until the corresponding printer 1 is reached, that is,

“Moving cost up to certain printer”=Σ (“moving cost up to the printer”)

the printing time can be concealed in a moving time accompanying collection.

Balance in printing load is then adjusted for each printer 1. That is, when Σ (printing load)>Σ (moving cost), an attempt is made to find out whether or not there is room where a page having a heavy printing load is replaced with the page of the printer 1 in which Σ (printing load)<Σ (moving cost). This attempt is repeated until a solution can be obtained. Part that cannot be adjusted appears in the form of a printing waiting time at each printer 1.

When there is any change in the printer 1, the control section 6 rewrites the page matching table. When the printer 1 is finally determined, the control section 6 sends the printing request of each page together with the image of the page to the selected printer 1.

Upon receiving the printing request, the printer 1 processes the image of the page, prints the image on a recording sheet and forms printed matter.

The control section 6 of the server 3 outputs the created output map so as to be available when the user collects the printed matter as described above. The user patrols each printer 1 according to the output map and collects the printed matter. Since the printed matter collected from each printer 1 is arranged in page order, the user can easily rearrange the printed matter without errors with reference to the output map.

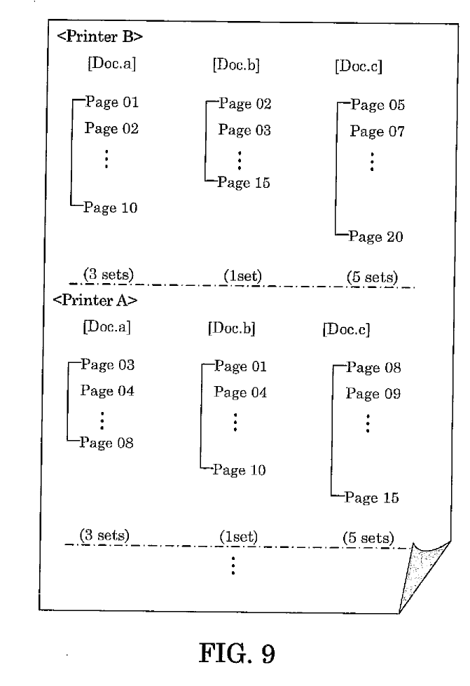

As shown in FIG. 9, the printers 1 are arranged in collection order in the output map. In this embodiment, the routing order as to what route should be used for the printers 1 is considered important during collection of the printed matter. Therefore, the notation order of the printers 1 is the item with a top priority in the output map. The user patrols the printers 1 in the order shown in the output map and collects the printed matter. This minimizes the moving time and printing waiting time. Therefore, the work efficiency after output improves and a system with high processing efficiency can be constructed as the image output system.

Since the notation order of jobs and the notation order of pages do not affect the priority items, these are not particularly specified. Here, the descending order is set by default. Furthermore, the output map may be divided and outputted by job, but division by printer 1 is not possible because of the nature of priority items.

When an X-Y plotter capable of outputting poster size data or a sublimation type color printer is set as the image processing apparatus, a plurality of image processing apparatuses are rarely located in the same place. When these image processing apparatuses are used, even when these image processing apparatuses are shared via the network, the user needs to move to a different room or building to collect printed matter. Furthermore, when one user needs to collect the printed matter distributed to these image processing apparatuses, the moving time alone may become a considerable amount. When setting conditions of such image processing apparatuses are special and the time and cost of collection cannot be ignored, it is beneficial to collect the printed matter using the output map of this embodiment.

The present invention is not limited to the above described embodiments and it goes without saying that many modifications and changes can be made to the above described embodiments within the scope of the present invention. The client apparatus or image processing apparatus may also serve as the load balancing server. Furthermore, the output map may also be created in a map format indicating the setting location of the image processing apparatus and shows page information in the area where each image processing apparatus is described. The user can determine the path to the image processing apparatus so as to efficiently collect printed matter with reference to the output map.

What is claimed is:

1. An image output system comprising a plurality of image processing apparatuses and an output management apparatus connected together via a network, the output management apparatus distributing a job composed of a plurality of pages to respective image processing apparatuses by dividing the pages in the image processing apparatuses, and the image processing apparatuses printing images for each page according to instructions from the output management apparatus,
wherein the output management apparatus creates an output map for use by a user to collect printed matter from the respective image processing apparatuses, showing page information on a page outputted to each image processing apparatus for each image processing apparatus.

2. The image output system according to claim 1, wherein the output map comprises page information arranged in output order.

3. The image output system according to claim 2, wherein the output management apparatus creates an output map based on a printing load for each page when printing an image of a page.

4. The image output system according to claim 1, wherein the output map comprises information on image processing apparatuses arranged in order of collection.

5. The image output system according to claim 4, wherein the output management apparatus creates an output map based on an optimum patrol path between the respective image processing apparatuses.

6. The image output system according to claim 1, wherein the output map comprises page information arranged in page order for each job.

7. The image output system according to claim 6, wherein the output map comprises index information indicating features of the image of each page.
